(19) United States
(12) Patent Application Publication
(10) Pub. No.: US 2026/0126989 A1
(43) Pub. Date: May 7, 2026

(54) FEATURE CONFIGURATION PARITY

(71) Applicant: Ivanti, Inc., South Jordan, UT (US)

(72) Inventors: Tohsheen Bazaz, Fair Lawn, NJ (US); Nandish KB, Bengaluru (IN); Phani Kumar Miryala, Telangana (IN)

(73) Assignee: Ivanti, Inc., South Jordan, UT (US)

(21) Appl. No.: 19/379,631

(22) Filed: Nov. 4, 2025

(30) Foreign Application Priority Data
Nov. 7, 2024 (IN) 202411085352

(51) Int. Cl. G06F 8/71

(52) U.S. Cl. CPC G06F 8/71

(57) ABSTRACT

A method of managing the configuration of software applications by importing different versions of the software, accessing their settings listings, and receiving selections for configurable features. It includes generating a feature parity file to compare the features of different versions and determining whether to distribute the new version based on this comparison. If there is feature parity, the new version is distributed to all endpoints. If not, a clone file is generated and distributed to a subset of endpoints for testing. Based on the test results, the new version is either distributed to the entire network or the clone file is maintained.

### CROSS-REFERENCE TO RELATED APPLICATION

This application claims priority to and the benefit of Indian Provisional Application No. 202411085352, filed November 7, 2024, which is incorporated herein by reference in its entirety.

### FIELD

The embodiments described in this disclosure are related to mobile device management (MDM) processes, and more particularly to systems and methods of feature configuration visualization and feature parity confirmation between software application versions.

### BACKGROUND

Endpoint devices such as mobile devices may be managed in systems referred to as mobile device management (MDM) system and unified endpoint management (UEM) systems. In general, MDM and UEM systems implement a service that enables a central system or a central console to control software applications and device settings on the endpoint devices. Control of the software applications and device settings may improve security posture of the endpoint devices and network or enterprise resources that are accessible to the endpoint devices.

An aspect of the software application management is application configuration, which is also referred to as a restriction schema. In application configuration, a list of features supported by an application or used at runtime may be provided to an administrator at the central console. Selection of settings of the features configures the application prior to it being published to the endpoint devices. Review and selection of the settings for the features may consume resources of the administrator.

New or updated versions of the software application may change one or more of the features. The changes to the features may result in inoperability after the updated versions are published to the endpoint devices. Moreover, elimination of features may remove or alter a setting that was previously selected by the administrator, which may result in security vulnerabilities or changes to use limitations by the endpoint devices. However, in conventional MDM and UEM systems, the updated versions may be dynamically published without administrative oversight or the administrator may be tasked with review of the features of the updated versions to ensure the upgraded version consistently applies the application configuration of a previous version. Accordingly, there is a need in MDM and UEM systems to enable feature visibility and feature parity confirmation.

The subject matter claimed herein is not limited to embodiments that solve any disadvantages or that operate only in environments such as those described. Rather, this background is only provided to illustrate one example of a technology area where some embodiments described herein may be practiced.

The object and advantages of the embodiments will be realized and achieved at least by the elements, features, and combinations particularly pointed out in the claims. It is to be understood that both the foregoing general description and the following detailed description are exemplary and explanatory and are not restrictive of the invention, as claimed.

### SUMMARY

According to an aspect of an embodiment includes a method of software application configuration management. The method may include importing a first version of a software application. The method may include accessing a first settings listing of the first version. The first settings listing may include one or more configurable features of the first version. The method may include receiving selections of settings for the configurable features on the settings listing. The method may include distributing the first version of the software application to one or more managed endpoints. The method may include storing the selections in a first configuration file for the first version of the application. The method may include importing a second version of the software application and accessing a second settings listing of the second version. The second settings listing including one or more configurable features of the second version. Prior to distribution of the second version, the method may include generating a feature parity file based on the first configuration file and the second setting listing. The parity file itemizes the configurable features of the first configuration file relative to the configurable features of the second settings listing. The parity file may indicate whether each of the configurable features of the first configuration file exist in the second settings listing or are removed in the second settings listing and may further indicate whether one of the configurable features of the second setting listing did not exist in the configurable file of the first version. The feature parity file may include a first column that includes the configurable features of the first version and the selected setting for each of the configurable features and a second column that includes the configurable features of the second version. The first and second columns may be organized according to the configurable features.

In response to the feature parity file indicating that there is feature parity between the first version and the second version, the method may include distributing the second version to the endpoints to replace the first version. In response to the feature parity file indicating that there is not feature parity between the first and the second versions, the method may include generating a clone file of the first configuration file and distributing the clone file to all but a subset of the endpoints. The method may include receiving selections of settings for the configurable features of the second settings listing. The method may include distributing the second version of the software application to the subset of the managed endpoints such that the second version is tested on the subset of the managed endpoints. The method may include storing the selections in a second configuration file for the second version of the application. Based on a test of the second version in the subset of the managed endpoints, the method may include determining that the second version is functional in the subset and distributing the second version to a managed network. Responsive to the second version not being functional in the subset, the method may include distributing the clone file to the subset and leaving the clone version operable in the managed network. The importing may be from a public application storefront and the accessing may be conducted from a vendor. The first and the second versions may be imported into a mobile device management (MDM) system. Additionally, the method may include causing display of a user interface that displays at least a portion of the feature parity file.

An additional aspect of an embodiment includes a non-transitory computer-readable medium having encoded therein programming code executable by one or more processors to perform or control performance at least a portion of the method described above.

Yet another aspect of an embodiment includes a computer device. The computer device may include one or more processors and a non-transitory computer-readable medium. The non-transitory computer-readable medium has encoded therein programming code executable by the one or more processors to perform or control performance of one or more of the operations of the methods described above.

The object and advantages of the embodiments will be realized and achieved at least by the elements, features, and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 is a block diagram of an example operating environment in which some embodiments described in the present disclosure may be implemented;

FIG. 2 is a block diagram of a feature configuration parity process (process) that may be implemented in the operating environment 100 of FIG. 1;

FIG. 3 illustrates an example computer system configured for feature configuration visualization and feature parity confirmation between software application versions;

FIGS. 4A-4C are a flow chart of an example method of software application configuration management; and

FIGS. 5A-5F are user interfaces that may be implemented in the process of FIG. 2,

all according to at least one embodiment described in the present disclosure.

### DESCRIPTION OF SOME EXAMPLE EMBODIMENTS

The embodiments described in this disclosure are related to mobile device management (MDM) and unified endpoint management (UEM) processes and systems. In particular, the embodiments of the present disclosure include systems and methods of feature configuration visualization and feature parity confirmation between software application versions.

For example, in some embodiments, an MDM or UEM system may pull a configuration schema of a managed application. The configuration schema may be pulled from an application marketplace such as the Google Play Store™. Based on the configuration schema, the administrator may view the features supported by a current version of the application. The administrator may select settings of the features to generate a current restriction schema for the application. The application may be deployed to managed devices with the current restriction schema. The current restriction schema may be stored for the application.

After the application is deployed, the application operating under the current restriction schema may be frozen, which may prevent automated or dynamic changes to the deployed application in response to an application developer releasing an updated version of the application. After the updated version is released by the application developer, an updated configuration schema for the updated version is retrieved (e.g., via the application marketplace). The updated configuration schema is compared to the current restriction schema to determine which of the features of the updated configuration schema have changed relative to the current restriction schema. The comparison is presented to the administrator with feature changes being indicated. The administrator is able to review the changes and make informed selections for an upgraded restriction schema for the updated version of the application. The updated version may then be deployed.

These embodiments enable an administrator to understand changes made by the application developer in its applications. Moreover, these embodiments enable the administrator to validate changes made by the third-party developer before deploying the updated version of the application to the endpoint devices. Accordingly, the MDM or UEM system maintains the protection and functionality provided by the current restriction schema.

These and other embodiments are described with reference to the appended Figures in which like item number indicates like function and structure unless described otherwise. The configurations of the present systems and methods, as generally described and illustrated in the Figures herein, may be arranged and designed in different configurations. Thus, the following detailed description of the Figures, is not intended to limit the scope of the systems and methods, as claimed, but is merely representative of example configurations of the systems and methods.

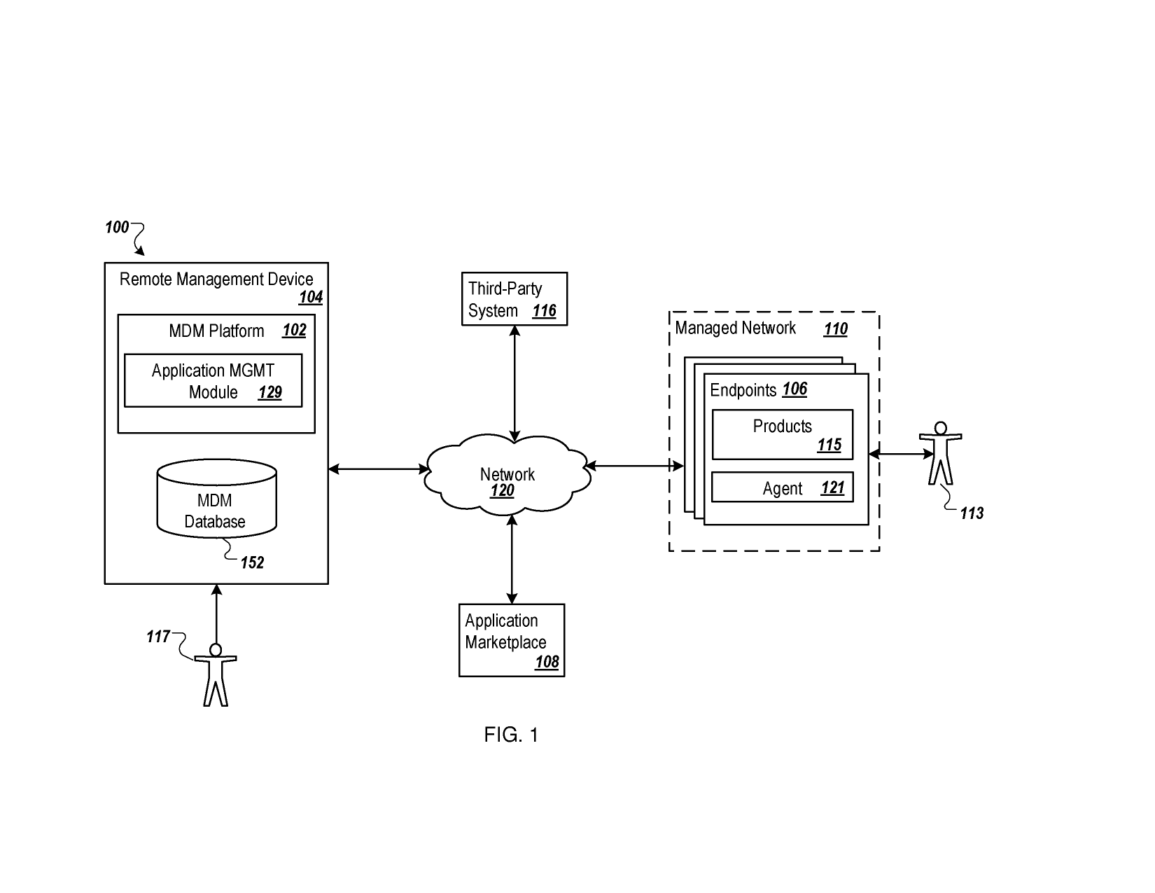

FIG. 1 is a block diagram of an example operating environment 100 in which some examples of the present disclosure can be implemented. The operating environment 100 may include an application management module 129 that is configured for feature configuration parity visualization and confirmation. The application management module 129 enables consistency of restriction schema between versions of an application deployed in a managed network 110. The application management module 129 is implemented in an MDM platform 102. In other embodiments, the application management module 129 may be implemented in another platform configured to manage or control the managed network 110 such as a UEM platform. In the operating environment 100, an MDM platform 102 may be configured to for application and content control. For instance, the MDM platform 102 may help enforce security policies, manage applications, and/or monitor the status of endpoints 106.

Examples of the present disclosure are directed to a computer-centric problem and are implemented in a computer-centric environment. For instance, the examples of the present disclosure are directed to MDM and UEM systems in the managed network 110. Communications during the processes described in this present disclosure involve the communication of data in electronic and optical forms via a network 120 and also involve the electrical and optical interpretation of the data and information.

The operating environment 100 may include the managed network 110, the endpoints 106, a third-party system 116, an application marketplace 108, and the remote management device 104. The components of the operating environment 100 are configured to communicate data and information via the network 120 to perform generation and implementation of predicates as described in the present disclosure. Each of these components are introduced below.

The network 120 may include any communication network configured for communication of signals between the components (e.g., 104, 116, 108, and 106) of the operating environment 100. The network 120 may be wired or wireless. The network 120 may have configurations including a star configuration, a token ring configuration, or another suitable configuration. Furthermore, the network 120 may include a local area network (LAN), a wide area network (WAN) (e.g., the Internet), and/or other interconnected data paths across which multiple devices may communicate. In some examples, the network 120 may include a peer-to-peer network. The network 120 may also be coupled to or include portions of a telecommunications network that may enable communication of data in a variety of different communication protocols.

In some examples, the network 120 includes or is configured to include a BLUETOOTH® communication network, a Z-Wave® communication network, an Insteon® communication network, an EnOcean® communication network, a Wi-Fi communication network, a ZigBee communication network, a representative state transfer application protocol interface (REST API) communication network, an extensible messaging and presence protocol (XMPP) communication network, a cellular communications network, any similar communication networks, or any combination thereof for sending and receiving data. The data communicated in the network 120 may include data communicated via short messaging service (SMS), multimedia messaging service (MMS), hypertext transfer protocol (HTTP), direct data connection, wireless application protocol (WAP), or any other protocol that may be implemented in the components of the operating environment 100.

The third-party system 116 may include a hardware-based server configured to communicate data and information with the other components of the operating environment 100 via the network 120. The third-party system 116 may be associated with a vendor or a developer of one or more versions of software applications that may be implemented in the managed network 110. For instance, the third-party system 116 may be associated with or managed by a vendor of one of the software applications, which may be implemented as one of the products 115.

In some embodiments, the third-party system 116 may develop the software application at a first time and release the software application. The MDM platform 102 may receive or access the software application. The software application may then be distributed to the endpoints 106 or a portion thereof where the software application may be implemented as one of a set of products 115. The immediately foregoing software application may be referred to as a first version of the software application. After the first version is released, the third-party system 116 may develop an update or modification to the software application, which may be accessed by the MDM platform 102. The update or modification to the software application may be referred to as a second version or an updated version.

The third-party system 116 may continue to develop and/or release updates to the software application. These later updates may be referred to as subsequent versions. In general in the present disclosure two versions of the software application are described. An earlier version is generally referred to as the first version and a later version is generally referred to as the second version.

In addition, the third-party system 116 may develop configuration schema for versions of the software applications. The configuration schema includes a settings listing. The settings listing may include one or more configurable features of each of the versions. For instance, each version might have one or more features that may be enabled, disabled, or otherwise set. The features modify the operation of the version. The configurable features may change between versions. Embodiments of the present disclosure ensure visibility of the configurable features prior to distribution of later or second versions of the software application.

The application marketplace 108 may include a hardware-based server configured to communicate data and information with the other components of the operating environment 100 via the network 120. The application marketplace 108 may host a digital exchange or distribution service in which one or more of the versions, the configuration schema, and information related to the configuration schema and versions may be accessible. For instance, in some embodiments the application management module 129 may import a second version from the application marketplace 108. The application management module 129 may the access the configuration schema from the third-party system 116 and further access information related to the configuration schema and the second version from the application marketplace 108. Some examples of the distribution service hosted by the application marketplace 108 may include Google Play®.

In some instances, the application marketplace 108 may be integrated with the third-party system 116. For instance, some software applications, the configuration schema, and information related thereto are accessible at the third-party system 116 instead of being distributed by the application marketplace 108. In these and other instances, operations described in the present disclosure may not include interface with the application marketplace 108. In some embodiments, the third-party system 116 may be part of the application marketplace 108. At the application marketplace 108, the software applications, the configuration schema, and information related thereto may be hosted together at the application marketplace 108. In these and other embodiments, the software application, the configuration schema, and the information related thereto may be accessed from the application marketplace 108 instead of from the third-party system 116. The software application, versions thereof, may be accesses indirectly through the application marketplace 108.

In FIG. 1, integration and communication between the third-party system 116 and the application marketplace 108 is represented by an integrated marketplace 131. The integrated marketplace 131 may be in use for some of the software applications and not for others. For instance, one or more versions a first software application may be accessed from the third-party system 116 and schema accessed from the application marketplace 108. Additionally, one or more versions of a second software and the schema related to the second software may be accessed from the application marketplace 108.

The managed network 110 includes the endpoints 106. The managed network 110 is implemented to enable management of the endpoints 106 by the remote management device 104. To implement the managed network 110, the endpoints 106 may be enrolled. After the endpoints 106 are enrolled, ongoing management of the endpoints 106 may be implemented by the remote management device 104. The ongoing management may include overseeing and dictating at least a part of the operations at the endpoints 106 as well as dictate or control policies such as application policies, security policies, communication policies, etc. at the endpoints 106 as described in the present disclosure. The managed network 110 may be associated with an enterprise, a portion of an enterprise, a government entity, or another entity or set of devices. The managed network 110 may be an MDM network in which the endpoints 106 are managed.

The endpoints 106 may include hardware-based computer systems that are configured to communicate with the other components of the operating environment 100 via the network 120. The endpoints 106 may include any computer device that may be managed by the remote management device 104 and/or have been enrolled in the managed network 110. The endpoints 106 include devices that are operated by the personnel and systems of an enterprise or store and process data of the enterprise. The endpoints 106 might include workstations of an enterprise, servers, data storage systems, printers, telephones, internet of things (IOT) devices, smart watches, sensors, automobiles, battery charging devices, scanner devices, etc. The endpoints 106 may also include virtual machines, which may include a portion of a single processing unit or one or more portions of multiple processing units, which may be included in multiple machines.

The endpoints 106 include the products 115 and an agent 121. The agents 121 may be locally installed, at least temporarily, at the endpoints 106. For instance, the agents 121 may be installed at the endpoints 106 when the endpoints 106 are enrolled in the managed network 110 or when a particular service is loaded at the endpoints 106. The agents 121 may have access to information related to the products 115 and may be configured to communicate the information such as product metadata related to the products 115 to the remote management device 104. For instance, the agent 121 may have access to information related to the products 115. On its own or responsive to a request (from the remote management device 104 or another endpoint 106), the agent 121 may communicate the information related to the products 115 to the remote management device 104. The information related to the products 115 may include a current inventory of the products 115 as well as information or product metadata related to the products 115 such as version, vendor, type, hardware integrations, size, privacy policy, software interfaces, and the like. The agents 121 may also implement administrative and/or management processes within the managed network 110.

The products 115 may include applications of any kind or type. Some examples of the products 115 may include software applications, enterprise software, operating systems, and the like. The products 115 may differ between the endpoints 106. When a software application or a version thereof is distributed to the endpoints 106, the distributed software application is one of the products 115. The products 115 may be individually updated in some circumstances. Additionally, two or more of the products 115 may be updated at the same time. Feature configuration of the two or more products 115 may be analyzed together. For instance, configuration schema related to two versions of different software applications may be evaluated concurrently and distributed as two or more of the products 115.

In some embodiments, one of the endpoints 106 may include the MDM platform 102. In these and other embodiments, the operations described herein relative to application configuration may be performed at least partially by the endpoint 106.

The remote management device 104 may include a hardware-based computer system that is configured to communicate with the other components of the operating environment 100 via the network 120. In some examples, the remote management device 104 may be a single server, a set of servers, a virtual device, or a virtual server in a cloud-based network of servers. In these and other examples, the MDM platform 102 and the monitoring module 105 may be spread over two or more cores, which may be virtualized across multiple physical machines.

The remote management device 104 may be configured for mobile device management (MDM) of the endpoints 106 in the managed network 110. In general, MDM of the endpoints 106 may include determining security policies, application policies, the security settings, network communication settings, etc. implemented at the endpoints 106. In some embodiments, the remote management device 104 may be configured to supply other management services unified endpoint management, service management (e.g., help desk and technical ticketing), patch or update management, application management, asset management, vulnerability detection, other management services, or combinations thereof.

In some embodiments, the remote management device 104 may include an application management module 129. The application management module 129 is configured for software application configuration management as described in the present disclosure. The application management module 129 may import a first version of a software application. For instance, the application management module 129 may import the first version into an MDM or UEM system such as the MDM or UEM system implemented by the MDM platform 102. After the first version is imported, the first version may be managed and distributable to the managed network 110. The application management module 129 may import the first version from a public application storefront such as the application marketplace 108 or the application management module 129 may access the first version from a vendor system such as the third-party system 116.

The application management module 129 may access a first settings listing of the first version. The first settings listing may include one or more configurable features of the first version. In some embodiments, the accessing the first settings listing includes authenticating a system with a vendor of the software application and communicating a query to the vendor that includes an API configured to receive the settings. For instance, the MDM platform 102 may authenticate itself or perform an authentication operation with the third-party system 116. After the MDM platform 102 is authenticated, the MDM platform 102 or the application management module 129 may communicate a query to the third-party system 116. The query may include an API that is configured to receive or to get the settings listing of the first version.

The application management module 129 may receive selections of settings for the configurable features on the settings listing. For instance, the administrator 117 may select one or more settings of the configurable features such as enabling one or more of the configurable features or disabling one or more of the configurable features.

The application management module 129 may distribute the first version of the software application to one or more managed endpoints 106. For instance, the selection of the configurable features may customize or control at least a portion of the operations of the first version when installed in as one of the products 115. The application management module 129 may store the selections. The selections may be stored in a first configuration file for the first version of the application. The selections may be stored in the MDM database 152 and may be accessible to the application management module 129 after it is stored.

After the first version is distributed, it may be implemented at the endpoints 106 as one of the products 115. During operation at the endpoints 106, the configurable features operate according to the received selections.

Additionally, after the first version is distributed, the third-party system 116 may generate a second version of the software application. For instance, the third-party system 116 may be a vendor of the software application. The third-party system 116 may improve or update the software application as the second version. The application management module 129 may import the second version of the software application. As described above, the application management module 129 may import the second version from the third-party system 116 or the application marketplace 108. The application management module 129 may access a second settings listing of the second version. The second settings listing may include one or more configurable features of the second version. The application management module 129 may generate a feature parity file. The application management module 129 may cause display of a user interface that displays at least a portion of the feature parity file.

The feature parity file may be generated prior to distribution of the second version. The feature parity file may be based on the first configuration file and the second setting listing. In some embodiments, the parity file itemizes the configurable features of the first configuration file relative to the configurable features of the second settings listing. The feature parity file indicates whether each of the configurable features of the first configuration file exist in the second settings listing or are removed in the second settings listing. In addition, the feature parity file indicates whether one of the configurable features of the second setting listing did not exist in the configurable file of the first version.

For example, there may be no or essentially no changes to the configurable features between the first version and the second version. Accordingly, the feature parity file may indicate that the selections made relative to the first version are applicable to the second version. Alternatively, the second version might change multiple configurable features. For instance, in the second version, one or more configurable features might be removed. Additionally or alternatively, in the second version one or more additional configurable features may be added relative to the first version. The feature parity file indicates these changes at a feature-by-feature level of granularity.

The feature parity file may include a first column that includes the configurable features of the first version and the selected setting for each of the configurable features. In addition, the feature parity file may include a second column that includes the configurable features of the second version. The first and second columns may be organized according to the configurable features. The feature parity file may provide visibility to the administrator 117, which may enable the administrator 117 to make informed decisions regarding distribution of the second version. In addition, the feature parity file may reduce or eliminate work associated with reviewing by the administrator 117 each of the configurable features of the second version. In particular, the administrator 117 can view the feature parity file and see which selections were made relative to the first version. The administrator 117 may then make similar or identical selections relative to comparable configurable features of the second version.

The application management module 129 may determine whether the feature parity file indicates that there is feature parity between the first version and the second version. In response to the feature parity file indicating that there is feature parity between the first version and the second version, the application management module 129 or the MDM platform 102 may distribute the second version to the endpoints 106 to replace the first version. In some embodiments, the selections made relative to the first version may be applied to the second version and the second version may be distributed. In these and other embodiments, the second version is configured similarly to the first version and may accordingly operate similarly to the first version.

In response to the feature parity file indicating that there is not feature parity between the first and the second versions, the application management module 129 may generate a clone file. The clone file may be based on or may be substantially similar to the first configuration file. The clone file is essentially the first version that was distributed to the endpoints 106.

The application management module 129 may distribute the clone file to all but a subset of the endpoints 106. The subset of the endpoints 106 may be a portion (e.g., 1%, 5%, or 10%) of the endpoints 106 on which the second version may be tested with the selections described below.

The application management module 129 may receive sections of settings for the configurable features of the second settings listing. The application management module 129 may distribute the second version to the subset of the endpoints 106 such that the second version is tested on the subset of the managed endpoints 106. Accordingly, in the managed network 110, the clone file is distributed to most of the endpoints 106 (e.g., all but subset) and the second version with the selections of the second settings listing is distributed to the subset. The application management module 129 may store the selections in a second configuration file for the second version of the application. The second configuration file may be stored at the MDM database 152.

The application management module 129 may determine whether the second version is functional in the subset. In the subset of the endpoints 106, the second version with the selections of the second settings listing is operational. The second version can be tested at the subset to determine whether it will operate according to the policies of the MDM platform 102 (and similarly to the first version). Responsive to the second version being functional in the subset, the application management module 129 may distribute the second version to a managed network 110 – i.e., the subset and the remaining endpoints. The determination may be based on a test of the second version in the subset of the managed endpoints 106. However, responsive to the second version not being functional in the subset, the application management module 129 may distribute the clone file to the subset. The clone version may be left operable in the managed network 110. In these circumstances, the first version with the selections made relative to the first version may be left in the managed network 110.

The MDM platform 102, the products 115, the agent 121, the application management module 129, combinations thereof, or components thereof may be implemented using hardware including a processor, a microprocessor (e.g., to perform or control performance of one or more operations), a field-programmable gate array (FPGA), or an application-specific integrated circuit (ASIC). In some other instances, the MDM platform 102, the products 115, the agent 121, the application management module 129, combinations thereof, or components thereof may be implemented using a combination of hardware and software. Implementation in software may include rapid activation and deactivation of one or more transistors or transistor elements such as may be included in hardware of a computing system (e.g., the endpoints 106 or the remote management device 104 of FIG. 1). Additionally, software defined instructions may operate on information within transistor elements. Implementation of software instructions may at least temporarily reconfigure electronic pathways and transform computing hardware.

Modifications, additions, or omissions may be made to the operating environment 100 without departing from the scope of the present disclosure. For example, the operating environment 100 may include one or more managed networks 110, one or more remote management devices 104, one or more endpoints 106, or any combination thereof. Moreover, the separation of various components and devices in the embodiments described herein is not meant to indicate that the separation occurs in all embodiments. Moreover, it may be understood with the benefit of this disclosure that the described components and servers may generally be integrated together into a single component or server or separated into multiple components or servers.

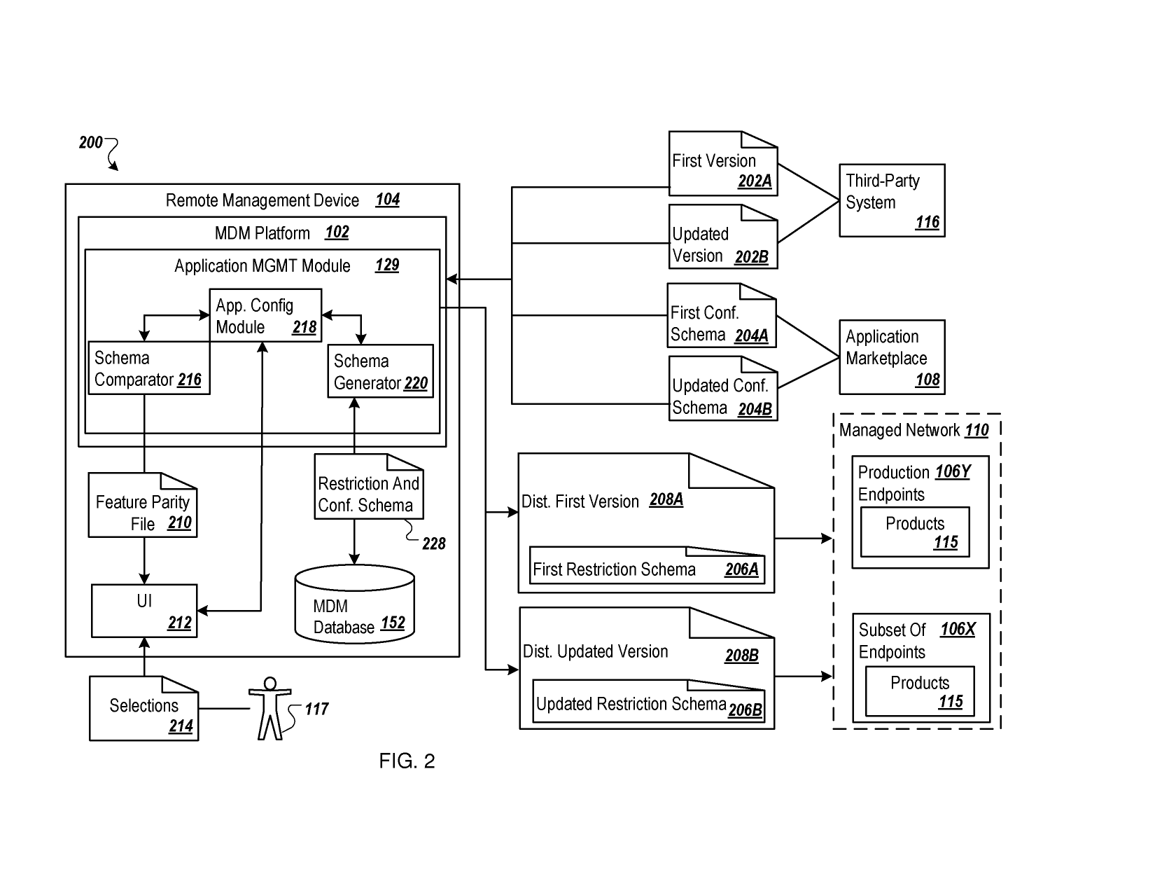

FIG. 2 is a block diagram of a feature configuration parity process (process) 200 that may be implemented in the operating environment 100 of FIG. 1 or another suitable operating environment. In FIG. 2 may include one or more components (e.g., the remote management device 104, the endpoints 106, the application marketplace 108, the third-party system 116, etc.) described with reference to FIG. 1. Although not depicted in FIG. 1, data may be communicated via communication network such as the network 120 of FIG. 1.

In FIG. 2, the endpoints 106 of FIG. 1 are separated into production endpoints 106Y and a subset of endpoints 106X. The production endpoints 106Y and the subset of endpoints 106X are collectively referred to as the endpoints 106. As described below, the subset of endpoints 106X may include a portion of the endpoints 106 such as one (1) to ten (10) percent of the endpoints 106. The subset of endpoints 106X may be implemented as a test group in some circumstances as described elsewhere in the present disclosure.

The process 200 may be implemented for software application configuration management. For example, the process 200 may be implemented to maintain consistent settings and operations between versions 202A and 202B of an application. In the embodiment of FIG. 2, an application, which may correspond to one of the products 115, may include a first version 202A and an updated version 202B. The first version 202A is released by the third-party system 116. Later, the third-party system 116 may release the updated version 202B. A first configuration schema 204A may be associated with the first version 202A and an update configuration schema 204B may be associated with the updated version 202B. The configuration schema 204A and 204B may include setting listings that include one or more configurable features of a corresponding version 202A or 202B. In some instances, the configuration schema 204A and 204B may differ. For instance, the first configuration schema 204A may include one or more configurable features that are removed in the updated version 202B. Additionally, the updated configuration schema 204B may include additional configurable features that were not available on the first version 202A.

Selection of the configurable features may help maintain control in the managed network 110 and accordingly be managed by the MDM platform 102. Changes to the configurable features without visibility and review by the administrator 117 may introduce technical issues or vulnerabilities to the managed network 110. For instance, if the first version 202A includes a password or certificate requirement setting that is removed in the updated version 202B, then deployment of the updated version 202B (e.g., that does not include the password or certificate requirement setting) to the managed network 110 may introduce a security vulnerability. The process 200 ensures that any changes to the configuration schema 204A or 204B are visible and such changes are accounted for prior to deployment.

The process 200 may begin with the MDM platform 102 importing the first version 202A. Importing the first version 202A may make the first version available for deployment and enable the administrator 117 to configure the features of the first version 202A. In some embodiments, the first version 202A may be imported from the third-party system 116. Additionally or alternatively, the first version 202A may be imported from the application marketplace 108. After the first version 202A is imported, the first version may be distributed to one or more of the endpoints 106 of the managed network 110.

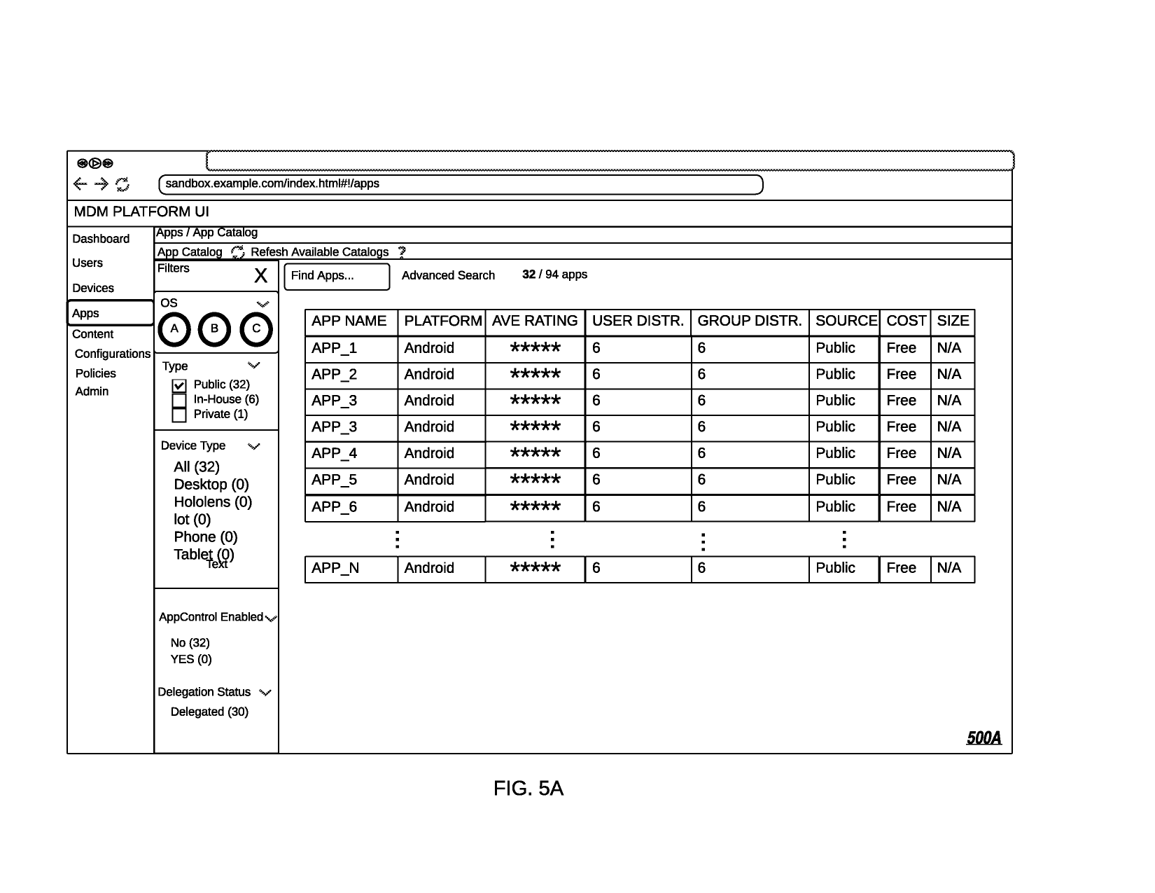

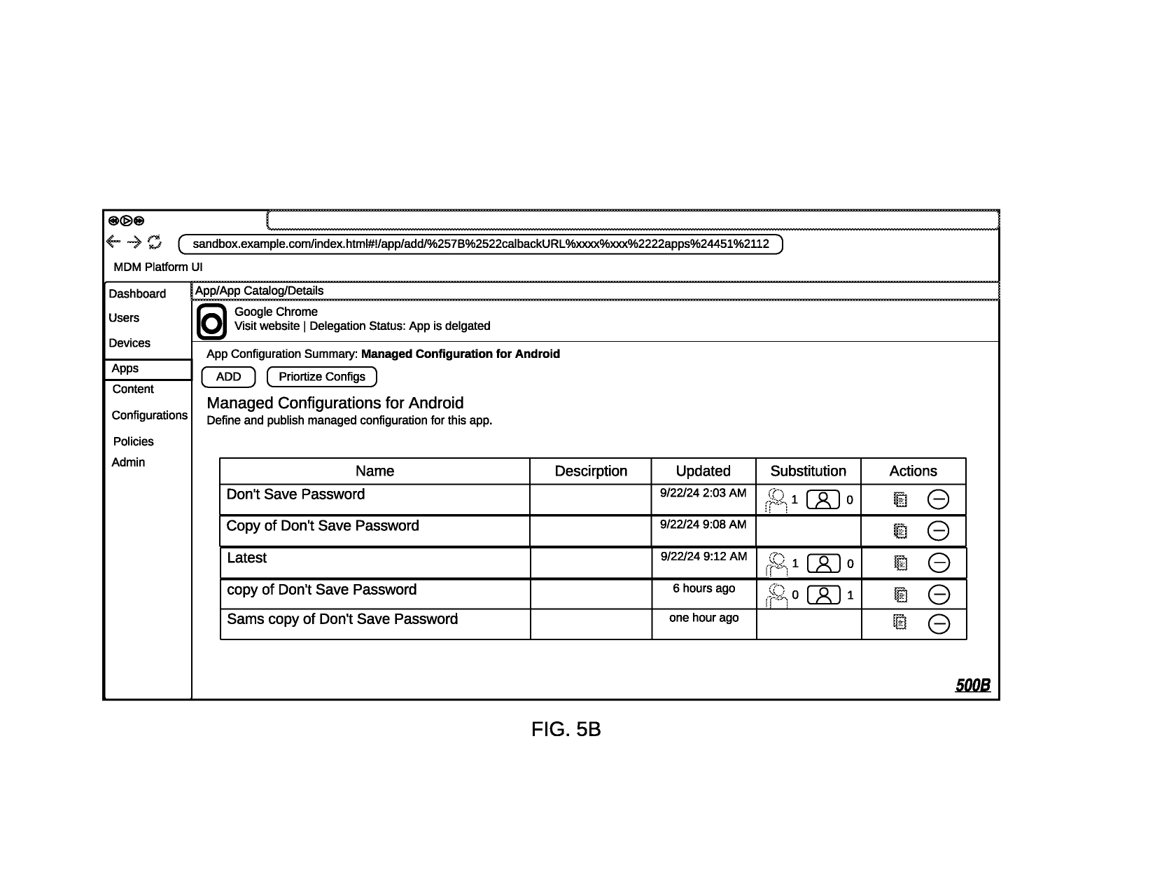

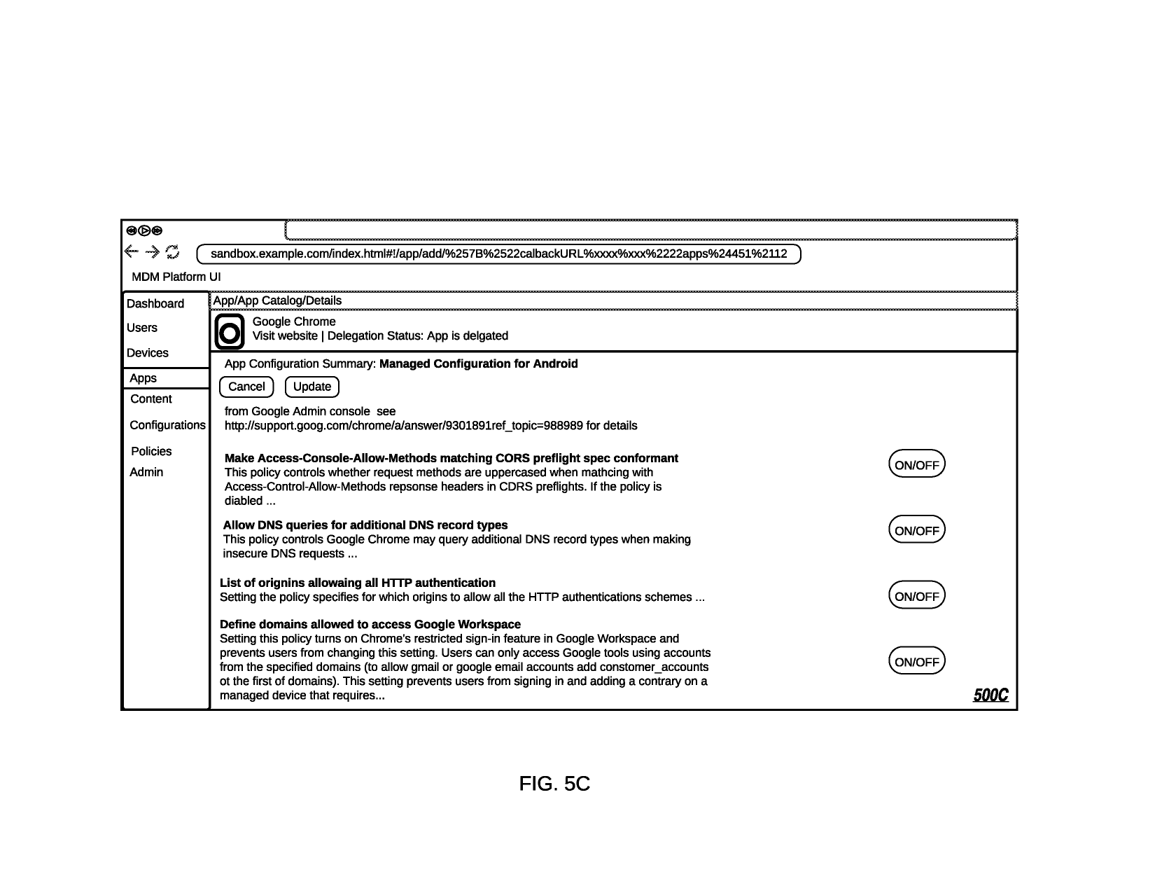

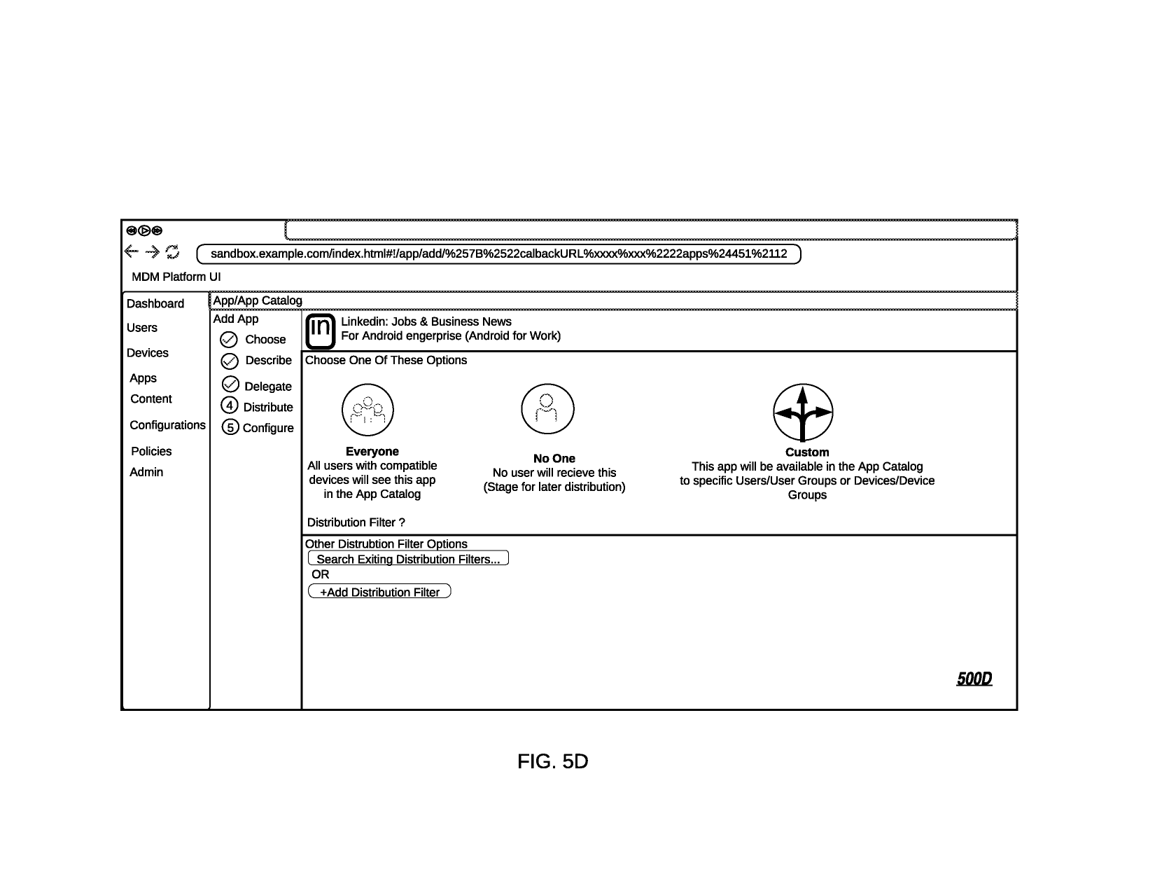

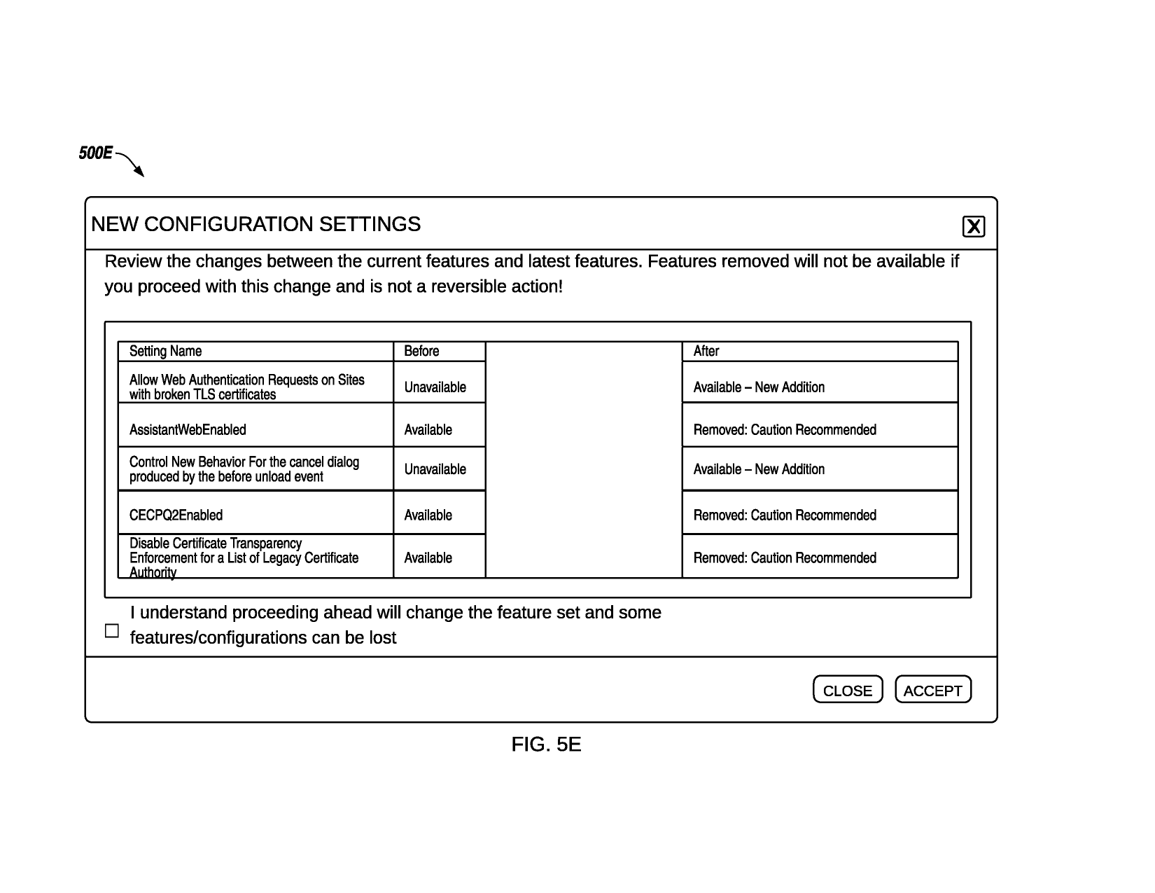

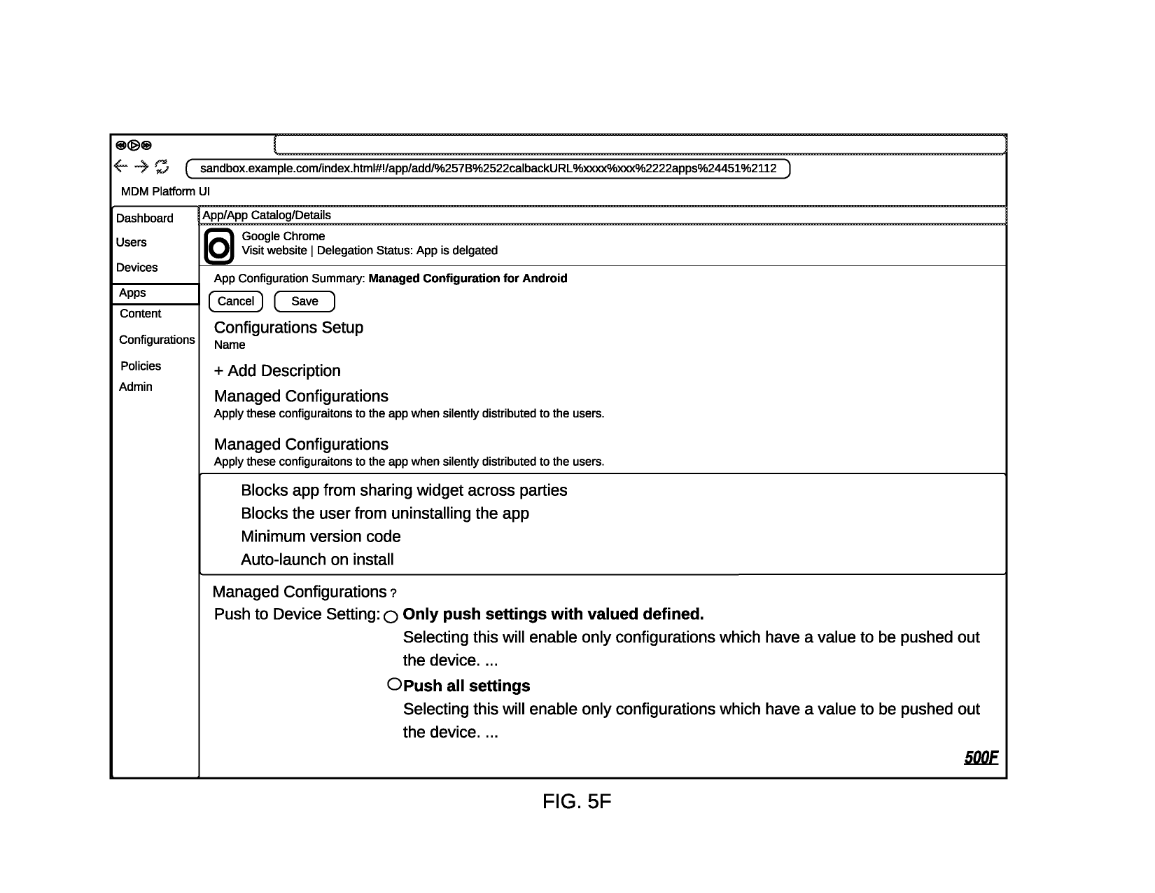

Referring to FIG. 5A, a screenshot of a first MDM user interface (UI) 500A is depicted. In the first MDM UI 500A, an application catalog is included. The application catalog includes a list of applications that are managed by the MDM platform 102. After the first version 202A is imported, it is displayed in the application catalog.

Referring back to FIG. 2, the MDM platform 102 may access the first configuration schema 204A. In some embodiments, the first configuration schema 204A may be accessed from the application marketplace 108. Additionally or alternatively, the first configuration schema 204A may be accessed from the third-party system 116. In these and other embodiments, the MDM platform 102 may communicate a query to the third-party system 116 that is configured to retrieve the first configuration schema 204A. For instance, the query may include an application programming interface (API) that is configured to retrieve the first configuration schema 204A.

The first configuration schema 204A may include one or more configurable features for the first version 202A. The configurable features may include optional or elective features that may dictate one or more aspects of the first version 202A. Some examples of the configurable features might include an option to block uniform resource locater (URL) for a browser, sync policies, email settings, password settings, certificate settings, and the like. An example of some managed configurations related to ANDROID™ may be found at: https://developer.android.com/work/managed-configurations.

An application configuration module 218 may pull the configurable features and cause display of the configurable features to the administrator 117. For instance, the configurable features may be displayed at a user interface (UI) 212. The administrator 117 may interact with the UI 212 to provide selections regarding the configurable settings. For example, FIGS. 5B and 5C are screenshots of a list of configurable settings that may be displayed at the UI 212. In the screenshots of FIG. 5B and 5C, there are selectable icons, fields, and buttons that enable the selection of one or more of the configurable settings. The selections for the configurable features may be received by the application configuration module 218 as depicted by selections 214 being input to the UI 212, which are then communicated to the application configuration module 218.

Referring back to FIG. 2, after the selections 214 are received, a schema generator 220 may be configured to generate a first restriction schema 206A. The first restriction schema 206A limits the functions of a distributed first version 208A. The distributed first version 208A, having the first restriction schema 206A operational, may be distributed to one or more managed endpoints 106. Accordingly, when the distributed first version 208A is installed at the endpoints 106 (e.g., as one of the products 115), functions of the distributed first version 208A are consistent with the first restriction schema 206A. For example, FIG. 5D depicts a distribution interface that may be implemented in the process 200. In the distribution interface of FIG. 5D an “everyone” button is selected, which may deploy the distributed first version 208A to the endpoints 106.

The MDM platform 102 may store the selections 214 and/or restriction and configuration schema 228 for the first version 202A. For instance, in FIG. 2, the schema generator 220 may communicate the restriction and configuration schema 228 to the MDM database 152. After the restriction and configuration schema 228 are stored, the restriction and configuration schema 228 may be accessible later to the application configuration module 218, a schema comparator 216, and other modules of the application management module 129. In some embodiments, the restriction and configuration schema 228 may be stored as a first configuration file for the first version 202A.

At a later time, the MDM platform 102 may import an updated version 202B of the software application. As described above, the updated version 202B may become available for distribution to the endpoints 106 after it is imported to the MDM platform 102. The updated version 202B may include some variation or derivation of the first version 202A. For instance, in general the updated version 202B may include similar functions to the first version 202A. However, there may be changes to configurable features between the first version 202A and the updated version 202B.

The MDM platform 102 may access an updated configuration schema 204B. Accessing the updated configuration schema 204B may be substantially similar to accessing the first configuration schema 204A described above. The updated configuration schema 204B may include a second settings listing that includes one or more configurable features of the updated version 202B.

The schema comparator 216 may generate a feature parity file 210. The feature parity file 210 may be generated prior to distribution of the updated version 202B. The feature parity file 210 may be based on the first configuration file and the second setting listing. In some embodiments, the feature parity file 210 itemizes the configurable features of the first configuration file relative to the configurable features of the second settings listing. The feature parity file 210 indicates whether each of the configurable features of the first configuration file exist in the second settings listing or are removed in the second settings listing. Additionally, the feature parity file 210 indicates whether one of the configurable features of the second setting listing that did not exist in the configurable file of the first version.

The application configuration module 218 may cause display of a user interface that displays at least a portion of the feature parity file 210. For example, FIG. 5E includes an example feature parity file UI 500E. The feature parity file UI 500E may be displayed at the UI 212 such that the administrator 117 can view and interact with the feature parity file UI 500E.

The feature parity file 210 (e.g., that depicted in the feature parity file UI 500E) may include a first column that includes the configurable features of the first version and the selected setting for each of the configurable features and a second column that includes the configurable features of the second version. The first and second columns may be organized according to the configurable features.

The schema comparator 216 may determine whether the feature parity file 210 indicates that there is feature parity between the first version 202A and the updated version 202B. In some circumstances, there may be additional or new configurable features in the updated version 202B. In these and other circumstances, the administrator 117 may provide additional selections 214. The schema generator 220 may generate an updated restriction schema 206B based on the selection 214 (if any). A distributed updated version 208B having the updated restriction schema 206B may be distributed to the managed network 110. The distributed updated version 208B may replace the distributed first version 208A implemented as one of the products 115 at the endpoints 106.

In response to the feature parity file 210 indicating that there is not feature parity between the first and the updated versions 202A and 202B, the application management module 129 may generate a clone file. The clone file may be based on or may be substantially similar to the distributed first version 208A with the first restriction schema 206A. For example, FIG. 5F depicts a clone generation UI. In the clone generation UI of FIG. 5F, the administrator 117 can provide input to replicate the first restriction schema 206A into a clone file.

The application management module 129 may distribute the clone file to the production endpoints 106Y. With reference to FIG. 5D, instead of selecting the “everyone” button, the “custom” button may be selected, which enable selection of the production endpoints 106Y or another customizable portion of the endpoints 106. The clone file is distributed to the product endpoints 106Y instead of the distributed updated version 208B. In some embodiments, the clone file and the distributed first version 208A are substantially similar or identical. Accordingly, the distribution of the clone file may not affect operation of the products 115 at the production endpoints 106Y. In addition, the application management module 129 may receive selections 214 for the configurable features of the second settings listing. That is, in response to the feature parity file 210 indicating that there are differences between the first configuration schema 204A and the updated configuration schema 204B, the administrator may input selections 214 that set the configurable features of the updated version 202B. The selections 214 may form the basis of the updated restriction schema 206B. The application management module 129 may distribute the distributed updated version 208B with the updated restriction schema 206B to the subset of endpoints 106X. The distributed updated version 208B may be distributed to the subset of the endpoints 106X such that the updated version 208B is tested on the subset of the managed endpoints 106X. In some embodiments, the selections 214 may be stored in a second configuration file for the updated version 202B.

The MDM platform 102 and/or the administrator 117 may determine whether the updated version 208B is functional in the subset of endpoints 106X. For example, the selections 214 made relative to the updated configuration schema 204B may operate similarly to the distributed first version 208A. Accordingly, the application management module 129 may distribute the updated version 208B to the production endpoints 106Y. Responsive to the updated version 208B not being functional in the subset of endpoints 106X, the application configuration module 218 may distribute the clone file to the subset of endpoints 106X. The MDM platform 102 may leave the clone version operable in the managed network 110.

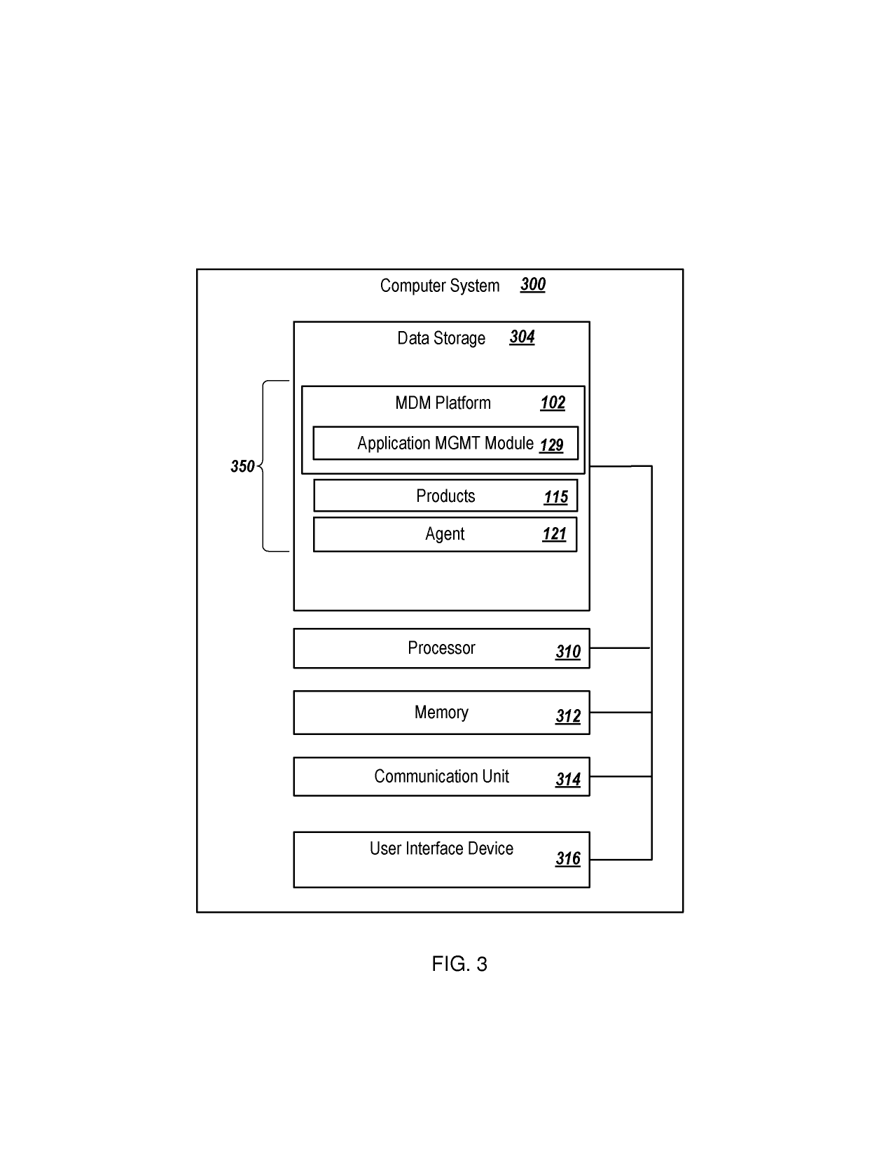

FIG. 3 illustrates an example computer system 300 configured for feature configuration visualization and feature parity confirmation between software application versions, according to at least one embodiment of the present disclosure. The computer system 300 may be implemented in the operating environment 100 FIG. 1, for instance. Examples of the computer system 300 may include the remote management device 104, one or more of the endpoints 106, an edge device, or some combination thereof. The computer system 300 may include one or more processors 310, a memory 312, a communication unit 314, a user interface device 316, and a data storage 304 that includes one or more or a combination of the MDM platform 102, the application management module 129, the products 115, and the agent 121 (collectively, system modules 350).

The processor 310 may include any suitable special-purpose or general-purpose computer, computing entity, or processing device including various computer hardware or software modules and may be configured to execute instructions stored on any applicable computer-readable storage media. For example, the processor 310 may include a microprocessor, a microcontroller, a digital signal processor (DSP), an ASIC, an FPGA, or any other digital or analog circuitry configured to interpret and/or to execute program instructions and/or to process data. Although illustrated as a single processor in FIG. 3, the processor 310 may more generally include any number of processors configured to perform individually or collectively any number of operations described in the present disclosure. Additionally, one or more of the processors 310 may be present on one or more different electronic devices or computing systems. In some embodiments, the processor 310 may interpret and/or execute program instructions and/or process data stored in the memory 312, the data storage 304, or the memory 312 and the data storage 304. In some embodiments, the processor 310 may fetch program instructions from the data storage 304 and load the program instructions in the memory 312. After the program instructions are loaded to the memory 312, the processor 310 may execute the program instructions.

The memory 312 and the data storage 304 may include computer-readable storage media for carrying or having computer-executable instructions or data structures stored thereon. Such computer-readable storage media may include any available media that may be accessed by a general-purpose or special-purpose computer, such as the processor 310. By way of example, and not limitation, such computer-readable storage media may include tangible or non-transitory computer-readable storage media including RAM, ROM, EEPROM, CD-ROM or other optical disk storage, magnetic disk storage or other magnetic storage devices, flash memory devices (e.g., solid state memory devices), or any other storage medium which may be used to carry or store desired program code in the form of computer-executable instructions or data structures and that may be accessed by a general-purpose or special-purpose computer. Combinations of the above may also be included within the scope of computer-readable storage media. Computer-executable instructions may include, for example, instructions and data configured to cause the processor 310 to perform a certain operation or group of operations.

The communication unit 314 may include one or more pieces of hardware configured to receive and send communications. In some embodiments, the communication unit 314 may include one or more of an antenna, a wired port, and modulation/demodulation hardware, among other communication hardware devices. In particular, the communication unit 314 may be configured to receive a communication from outside the computer system 300 and to present the communication to the processor 310 or to send a communication from the processor 310 to another device or network (e.g., the network 120 of FIG. 1).

The user interface device 316 may include one or more pieces of hardware configured to receive input from and/or provide output to a user. In some embodiments, the user interface device 316 may include one or more of a speaker, a microphone, a display, a keyboard, a touch screen, or a holographic projection, among other hardware devices.

The system modules 350 may include program instructions stored in the data storage 304. The processor 310 may be configured to load the system modules 350 to the memory 312 and execute the system modules 350. Alternatively, the processor 310 may execute the system modules 350 line-by-line from the data storage 304 without loading them to the memory 312. When executing the system modules 350, the processor 310 may be configured to perform one or more processes or operations described elsewhere in this disclosure.

Modifications, additions, or omissions may be made to the computer system 300 without departing from the scope of the present disclosure. For example, in some embodiments, the computer system 300 may not include the user interface device 316. In some embodiments, the different components of the computer system 300 may be physically separate and may be communicatively coupled via any suitable mechanism. For example, the data storage 304 may be part of a storage device that is separate from a device, which includes the processor 310, the memory 312, and the communication unit 314, that is communicatively coupled to the storage device. The embodiments described herein may include the use of a special-purpose or general-purpose computer including various computer hardware or software modules, as discussed in greater detail below.

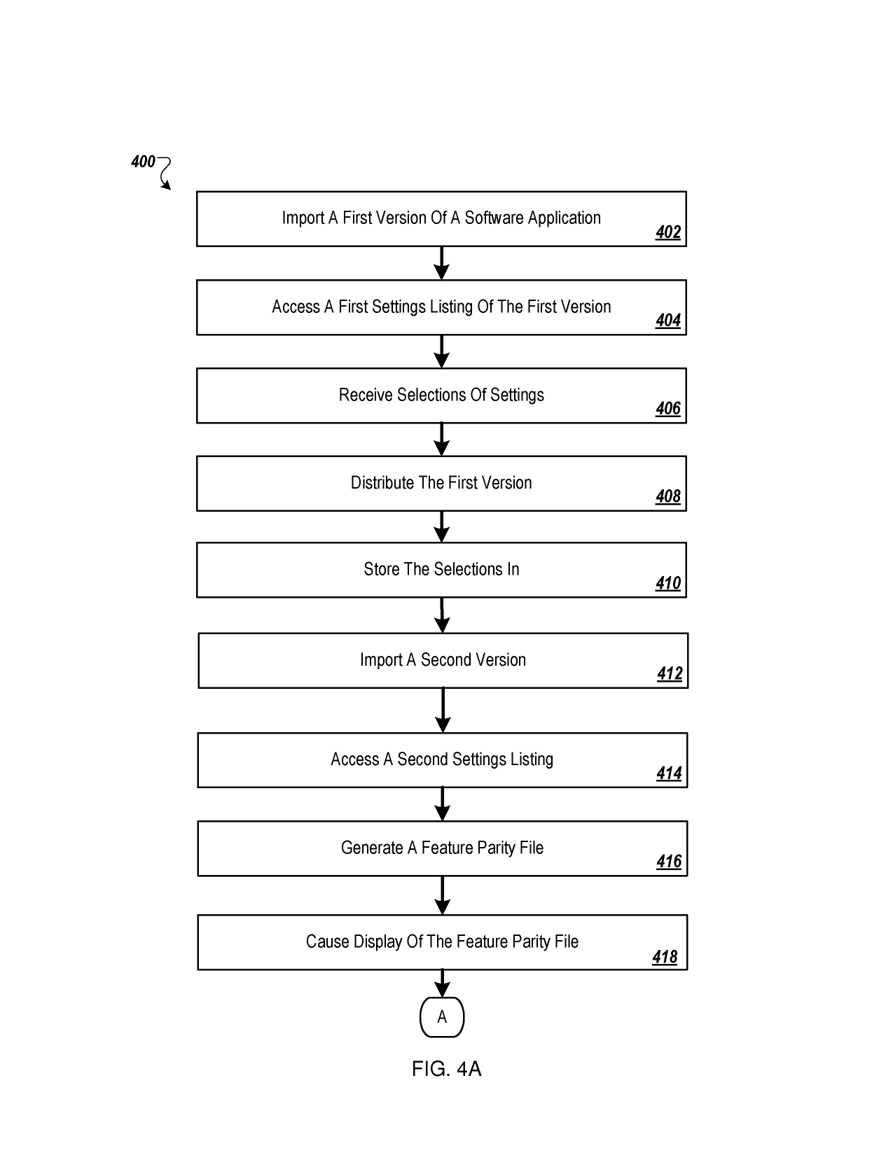

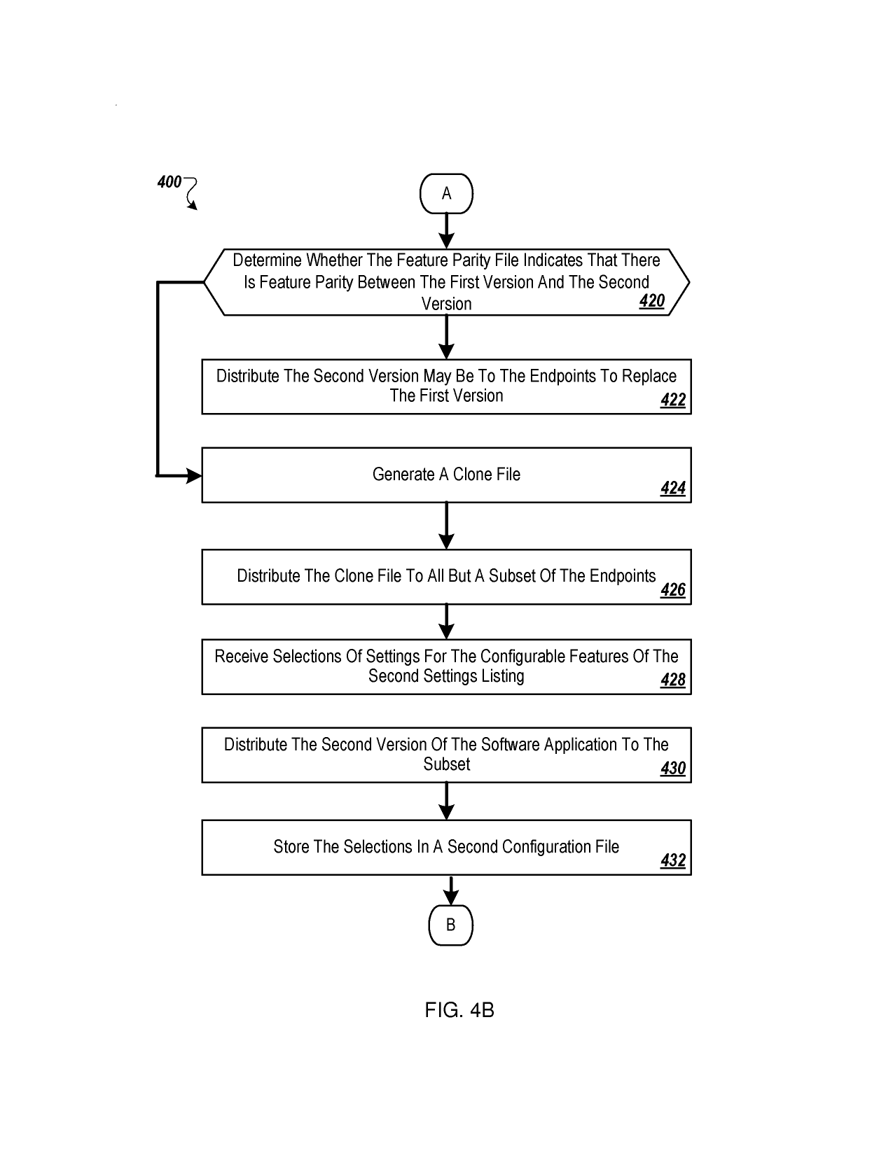

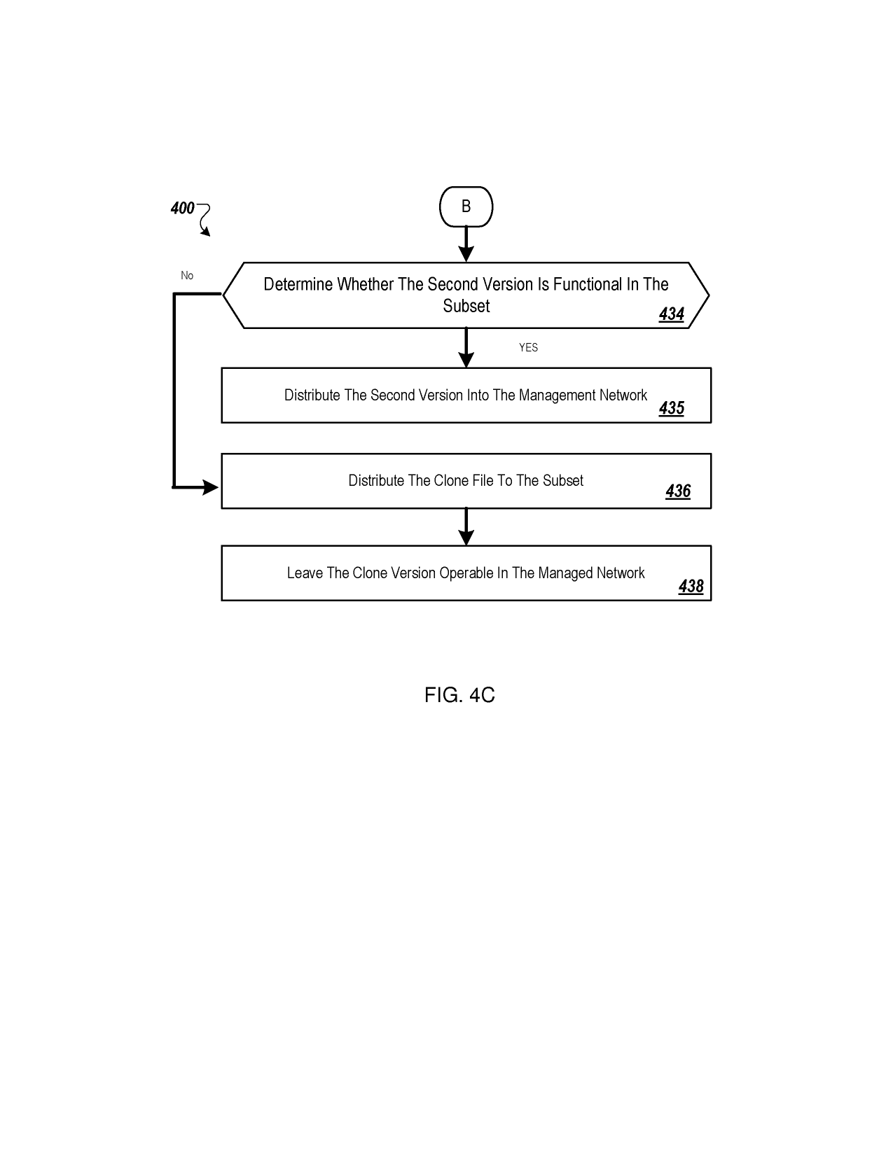

FIG. 4A-4C are a flowchart of an example method 400 of software application configuration management, according to at least one embodiment of the present disclosure. The method 400 may begin at block 402 of FIG. 4A, in which a first version of a software application may be imported. For instance, the first version may be imported into an MDM or UEM system in which the first version may be distributed to one or more endpoints of a managed network. The importing may be from a public application storefront and the accessing is conducted from a vendor.

At block 404, a first settings listing of the first version may be accessed. The first settings listing may include one or more configurable features of the first version. In some embodiments, the accessing the files includes authenticating a system with a vendor of the software application and communicating a query to the vendor that includes an API configured to receive the settings.

At block 406, selections of settings may be received for the configurable features on the settings listing. At block 408, the first version of the software application may be distributed to one or more managed endpoints. At block 410, the selections may be stored. The selections may be stored in a first configuration file for the first version of the application. At block 412, a second version of the software application may be imported.

At block 413, it may be determined whether an update is required. For instance, an administrator may review the content of the second version. In some circumstances, the second version may address a vulnerability, enable an important functionality, etc. Accordingly, the second version may be required to ensure functionality and security. In these circumstances, the second version may be required and it may not be optional to continue to operate using the first version. Responsive to the update being required (“Yes” at block 413), the method 400 may proceed to block 440 of FIG. 4C. Responsive to the update not being required, the method 400 may proceed to block 414. At block 414, a second settings listing of the second version may be accessed. The second settings listing may include one or more configurable features of the second version.

Referring to FIG. 4B, at block 416, a feature parity file may be generated. The feature parity file may be generated prior to distribution of the second version. The feature parity file may be based on the first configuration file and the second setting listing. In some embodiments, the parity file itemizes the configurable features of the first configuration file relative to the configurable features of the second settings listing. indicates whether each of the configurable features of the first configuration file exist in the second settings listing or are removed in the second settings listing and indicates whether one of the configurable features of the second setting listing did not exist in the configurable file of the first version. The feature parity file may include a first column that includes the configurable features of the first version and the selected setting for each of the configurable features and a second column that includes the configurable features of the second version. The first and second columns may be organized according to the configurable features. At block 418, display of a user interface that displays at least a portion of the feature parity file may be caused.

At block 420 it may be determined whether the feature parity file indicates that there is feature parity between the first version and the second version. In response to the feature parity file indicating that there is feature parity between the first version and the second version (“Yes” at block 420), the method 400 may proceed to block 422 in which the second version may be distributed to the endpoints to replace the first version. In response to the feature parity file indicating that there is not feature parity between the first and the second versions (“No” at block 420), the method 400 may proceed to block 424. At block 424, a clone file may be generated. The clone file may be based on or may be substantially similar to the first configuration file. At block 426, the clone file may be distributed to all but a subset of the endpoints. At block 428, sections may be received of settings for the configurable features of the second settings listing. At block 430, the second version may be distributed to the subset of the managed endpoints such that the second version is tested on the subset of the managed endpoints. At block 432, the selections may be stored in a second configuration file for the second version of the application.

Referring to FIG. 4C, at block 434, it may be determined whether the second version is functional in the subset. In response to the second version being functional at the subset (“Yes” at block 434), the method 400 may proceed to block 435. At block 435, the second version may be distributed to a managed network. The determination may be based on a test of the second version in the subset of the managed endpoints. Responsive to the second version not being functional in the subset (“No” at block 434), the method 400 may proceed to block 436. At block 436, the clone file may be distributed to the subset. At block 438, the clone version may be left operable in the managed network. At block 440, an update may be performed when required. As discussed with reference to block 413, in some circumstances, some updates may include changes to functionality or address vulnerabilities. In these and other circumstances, an update may be required. In these circumstances, the update may be performed. The update may be performed relative to the clone version or relative to an earlier version (e.g., the first version).

The method 400 may be performed by the remote management device 104 described elsewhere in the present disclosure or by another suitable computing system, such as the computer system 300 of FIG. 3. In some embodiments, the remote management device 104 or the other computing system may include or may be communicatively coupled to a non-transitory computer-readable medium (e.g., the memory 312 of FIG. 3) having stored thereon programming code or instructions that are executable by one or more processors (such as the processor 310 of FIG. 3) to cause a computing system or the remote management device 104 to perform or control performance of the method 400. Additionally or alternatively, the remote management device 104 may include the processor 310 that is configured to execute computer instructions to cause the remote management device 104 or other computing systems to perform or control performance of the method 400. The remote management device 104 or the computer system 300 implementing the method 400 may be included in a cloud-based managed network, an on-premises system, or another suitable network computing environment. Although illustrated as discrete blocks, one or more blocks in FIG. 3 may be divided into additional blocks, combined into fewer blocks, or eliminated, depending on the desired implementation.

The embodiments described herein may include the use of a special purpose or general-purpose computer including various computer hardware or software modules, as discussed in greater detail below.

Embodiments described herein may be implemented using computer-readable media for carrying or having computer-executable instructions or data structures stored thereon. Such computer-readable media may be any available media that may be accessed by a general purpose or special purpose computer. By way of example, and not limitation, such computer-readable media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general purpose or special purpose computer. Combinations of the above may also be included within the scope of computer-readable media.

Computer-executable instructions may include, for example, instructions and data, which cause a general-purpose computer, special purpose computer, or special purpose processing device (e.g., one or more processors) to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the terms “module” or “component” may refer to specific hardware implementations configured to perform the operations of the module or component and/or software objects or software routines that may be stored on and/or executed by general purpose hardware (e.g., computer-readable media, processing devices, etc.) of the computing system. In some embodiments, the different components, modules, engines, and services described herein may be implemented as objects or processes that execute on the computing system (e.g., as separate threads). While some of the system and methods described herein are generally described as being implemented in software (stored on and/or executed by general purpose hardware), specific hardware implementations or a combination of software and specific hardware implementations are also possible and contemplated. In this description, a “computing entity” may be any computing system as previously defined herein, or any module or combination of modulates running on a computing system.

The various features illustrated in the drawings may not be drawn to scale. The illustrations presented in the present disclosure are not meant to be actual views of any particular apparatus (e.g., device, system, etc.) or method, but are representations employed to describe embodiments of the disclosure. Accordingly, the dimensions of the features may be expanded or reduced for clarity. In addition, some of the drawings may be simplified for clarity. Thus, the drawings may not depict all of the components of a given apparatus (e.g., device) or all operations of a particular method.

Terms used in the present disclosure and the claims (e.g., bodies of the appended claims) are intended as “open” terms (e.g., the term “including” should be interpreted as “including, but not limited to,” the term “having” should be interpreted as “having at least,” the term “includes” should be interpreted as “includes, but is not limited to,” among others). Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in instances in which a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. Further, any disjunctive word or phrase presenting two or more alternative terms should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

The terms “first,” “second,” “third,” etc., are not necessarily used to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art and are to be construed as being without limitation to such specifically recited examples and conditions. Although embodiments of the present inventions have been described in detail, it should be understood that the various changes, substitutions, and alterations could be made hereto without departing from the scope of the invention.

What is claimed is:

1. A method of software application configuration management, the method comprising:
importing a first version of a software application;
accessing a first settings listing of the first version, the first settings listing including one or more configurable features of the first version;
receiving selections of settings for the configurable features on the settings listing;
distributing the first version of the software application to one or more managed endpoints;
storing the selections in a first configuration file for the first version of the application;
importing a second version of the software application;
accessing a second settings listing of the second version, the second settings listing including one or more configurable features of the second version;
prior to distribution of the second version, generating a feature parity file based on the first configuration file and the second setting listing, wherein:
the parity file itemizes the configurable features of the first configuration file relative to the configurable features of the second settings listing, and
indicates whether each of the configurable features of the first configuration file exist in the second settings listing or are removed in the second settings listing,
indicates whether one of the configurable features of the second setting listing did not exist in the configurable file of the first version;
in response to the feature parity file indicating that there is feature parity between the first version and the second version, distributing the second version to the endpoints to replace the first version; and
in response to the feature parity file indicating that there is not feature parity between the first and the second versions:
generating a clone file of the first configuration file and distributing the clone file to all but a subset of the endpoints;
receiving selections of settings for the configurable features of the second settings listing;
distributing the second version of the software application to the subset of the managed endpoints such that the second version is tested on the subset of the managed endpoints;
storing the selections in a second configuration file for the second version of the application;
based on a test of the second version in the subset of the managed endpoints, determining that the second version is functional in the subset and distributing the second version to a managed network; and
responsive to the second version not being functional in the subset, distributing the clone file to the subset and leaving the clone file operable in the managed network.

2. The method of claim 1, wherein the first and the second version are imported into a mobile device management (MDM) system.

3. The method of claim 1, further comprising causing display of a user interface that displays at least a portion of the feature parity file.

4. The method of claim 1, wherein the accessing the files includes
authenticating a system with a vendor of the software application
communicating a query to the vendor that includes an API configured to receive the settings.

5. The method of claim 1, wherein the importing is from a public application storefront and the accessing is conducted from a vendor.

6. The method of claim 1, wherein the feature parity file includes:
a first column that includes the configurable features of the first version and the selected setting for each of the configurable features; and
a second column that includes the configurable features of the second version,
wherein the first and second columns are organized according to the configurable features.

7. A non-transitory computer-readable medium having encoded therein programming code executable by one or more processors to perform or control performance of operations of software application configuration management, the operations comprising:
importing a first version of a software application;
accessing a first settings listing of the first version, the first settings listing including one or more configurable features of the first version;
receiving selections of settings for the configurable features on the settings listing;
distributing the first version of the software application to one or more managed endpoints;
storing the selections in a first configuration file for the first version of the application;
importing a second version of the software application;
accessing a second settings listing of the second version, the second settings listing including one or more configurable features of the second version;
prior to distribution of the second version, generating a feature parity file based on the first configuration file and the second setting listing, wherein:
the parity file itemizes the configurable features of the first configuration file relative to the configurable features of the second settings listing, and
indicates whether each of the configurable features of the first configuration file exist in the second settings listing or are removed in the second settings listing,
indicates whether one of the configurable features of the second setting listing did not exist in the configurable file of the first version;
in response to the feature parity file indicating that there is feature parity between the first version and the second version, distributing the second version to the endpoints to replace the first version; and
in response to the feature parity file indicating that there is not feature parity between the first and the second versions:
generating a clone file of the first configuration file and distributing the clone file to all but a subset of the endpoints;
receiving selections of settings for the configurable features of the second settings listing;
distributing the second version of the software application to the subset of the managed endpoints such that the second version is tested on the subset of the managed endpoints;
storing the selections in a second configuration file for the second version of the application;
based on a test of the second version in the subset of the managed endpoints, determining that the second version is functional in the subset and distributing the second version to a managed network; and
responsive to the second version not being functional in the subset, distributing the clone file to the subset and leaving the clone file operable in the managed network.

8. The non-transitory computer-readable medium of claim 7, wherein the first and the second version are imported into a mobile device management (MDM) system.

9. The non-transitory computer-readable medium of claim 7, wherein the operations further comprise causing display of a user interface that displays at least a portion of the feature parity file.

10. The non-transitory computer-readable medium of claim 7, wherein the accessing the files includes:
authenticating a system with a vendor of the software application; and
communicating a query to the vendor that includes an API configured to receive the settings.

11. The non-transitory computer-readable medium of claim 7, wherein the importing is from a public application storefront and the accessing is conducted from a vendor.

12. The non-transitory computer-readable medium of claim 7, wherein:
the feature parity file includes:
a first column that includes the configurable features of the first version and the selected setting for each of the configurable features; and
a second column that includes the configurable features of the second version; and
the first and second columns are organized according to the configurable features.

13. A computer device comprising:
one or more processors; and
a non-transitory computer-readable medium having encoded therein programming code executable by the one or more processors to perform or control performance of operations of software application configuration management, the operations comprising:
importing a first version of a software application;
accessing a first settings listing of the first version, the first settings listing including one or more configurable features of the first version;
receiving selections of settings for the configurable features on the settings listing;
distributing the first version of the software application to one or more managed endpoints;
storing the selections in a first configuration file for the first version of the application;
importing a second version of the software application;
accessing a second settings listing of the second version, the second settings listing including one or more configurable features of the second version;
prior to distribution of the second version, generating a feature parity file based on the first configuration file and the second setting listing, wherein:
the parity file itemizes the configurable features of the first configuration file relative to the configurable features of the second settings listing, and
indicates whether each of the configurable features of the first configuration file exist in the second settings listing or are removed in the second settings listing,
indicates whether one of the configurable features of the second setting listing did not exist in the configurable file of the first version;
in response to the feature parity file indicating that there is feature parity between the first version and the second version, distributing the second version to the endpoints to replace the first version; and
in response to the feature parity file indicating that there is not feature parity between the first and the second versions:
generating a clone file of the first configuration file and distributing the clone file to all but a subset of the endpoints;
receiving selections of settings for the configurable features of the second settings listing;
distributing the second version of the software application to the subset of the managed endpoints such that the second version is tested on the subset of the managed endpoints;
storing the selections in a second configuration file for the second version of the application;
based on a test of the second version in the subset of the managed endpoints, determining that the second version is functional in the subset and distributing the second version to a managed network; and
responsive to the second version not being functional in the subset, distributing the clone file to the subset and leaving the clone file operable in the managed network.

14. The computer device of claim 13, wherein the first and the second version are imported into a mobile device management (MDM) system.

15. The computer device of claim 13, wherein the operations further comprise causing display of a user interface that displays at least a portion of the feature parity file.

16. The computer device of claim 13, wherein the accessing the files includes:
authenticating a system with a vendor of the software application; and
communicating a query to the vendor that includes an API configured to receive the settings.

17. The computer device of claim 13, wherein the importing is from a public application storefront and the accessing is conducted from a vendor.

18. The computer device of claim 13, wherein:
the feature parity file includes:
a first column that includes the configurable features of the first version and the selected setting for each of the configurable features; and
a second column that includes the configurable features of the second version; and
the first and second columns are organized according to the configurable features.
